(19) United States
(12) Patent Application Publication
(10) Pub. No.: US 2012/0091046 A1
(43) Pub. Date: Apr. 19, 2012

(54) WATER RESERVOIR WITH A WATER PURIFICATION FUNCTION

(76) Inventor: WEN-LO CHEN, Taipei City (TW)

(21) Appl. No.: 12/905,059

(22) Filed: Oct. 14, 2010

(51) Int. Cl. C02F 1/78; C02F 1/50

(52) U.S. Cl. 210/97; 210/192

(57) ABSTRACT

A water reservoir includes a water storage unit having an external water pipe connected to an external water source and one or a number of internal water pipes suspending therein, airstones wrapped about each internal water pipe corresponding to jet holes of each internal water pipe, and an ozone generator installed in between the external water pipe and the internal water pipes for generating ozone into water passing through the external water pipe and the internal water pipes into the inside of the water storage unit.

### BACKGROUND OF THE INVENTION

a) Field of the Invention

The present invention relates to water towers and more particularly, to a water reservoir that provides a water purification function.

b) Description of the Prior Art

A building generally has a first water reservoir installed in the basement and a second water reservoir installed in the roof City water is guided to the first water reservoir in the basement and then pumped by a water pump to the second water reservoir for further distribution to every house in the building. Normally, the first and second water reservoirs are water storage devices of reinforced concrete or stainless steel. Moss and scale may be formed on the inner surface of a water reservoir after a long use. Therefore, the water reservoirs of buildings must be regularly washed and sterilized. Washing and sterilizing a building water reservoir is time and labor consuming. Further, water supply is interrupted during cleaning of a building water reservoir.

### SUMMARY OF THE INVENTION

The present invention has been accomplished under the circumstances in view. It is one object of the present invention to provide a water reservoir that provides a water purification function, assuring drinking water safety and hygiene. It is another object of the present invention to provide a water reservoir that utilizes ozone to sterilize water, avoiding growing of moss and formation of scale.

Further, the ozone layer in the upper atmosphere filters potentially damaging ultraviolet light from reaching the Earth's surface. Ozone is mainly located in the lower portion of the stratosphere from approximately 10 km to 50 km above Earth, though the thickness varies seasonally and geographically. Further, ozone is present in low concentrations (0.01˜0.04 ppm) throughout the Earth's atmosphere to prevent abnormal growth of bacteria. However, continuous increase of CFC (chlorofiurocarbon) gas in the atmosphere causes the ozone layer to be seriously weakened. According to investigation, the Earth's surface temperature has raised 2oC when compared to the record 50 years ago. In consequence, the average environmental magnetic field has dropped from the early 0.5 Gauss to the present 0.45 Gauss.

Further, it is well known that ozone has characteristics as follows:

(1) The half-life period of ozone is about 30 seconds in the atmosphere (normal temperature), and may vary with temperature.

(2) The half-life period of ozone is about 20 minutes in water. The decomposing speed of ozone will be accelerated when Ph value in water is high, or slowed down when Ph value in water is low.

(3) When ozone is dissolved in water, it will be decomposed rapidly subject to the effect of water molecules, producing strong oxidizing, bacteria-killing, odor-eliminating and bleaching effects.

(4) Ozone reacts with adhered substances in water before or after decomposition.

(5) [HO—] is produced after decomposition reaction of ozone.

(6) The oxidizing power of hydroxide ions is −2.8V, higher than ozone.

(7) The oxidizing power of ozone is −2.7V in an acidic solution, or −1.2V in an alkaline solution.

(8) When decomposed with harmful substances, ozone is reduced into oxygen without causing any secondary pollution.

Further, it is well known that ozone is a triatomic molecule consisting of three oxygen atoms, having many industrial and consumer applications. When compared to chlorine or cresol, ozone shows a better result in bacteria killing. Further, bacteria are single-celled microorganisms which can exist either as independent (free-living) organisms or as parasites (dependent upon another organism for life). Bacterial particles consist of protein, polysaccaride and lipids. Further, virus is a small infectious agent that can replicate only inside the living cells of organisms. Virus particles consist of genes made from either DNA or RNA, long molecules that carry genetic information; a protein coat that protects these genes, and in some cases an envelope of lipids that surrounds the protein coat. To kill or inactivate bacteria or virus, it is necessary to destroy or decompose their contents. Ozone can penetrate bacteria and virus, causing them to be changed into enzyme. Thus, RNA can be decomposed, and DNA can be destroyed.

Further, ozone can be decomposed into O2 molecules and oxygen atom. Ozone's deodorizing action is a chemical destruction of the compounds that create the odors Ozone deodorization is extremely effective for more serious odor. Ozone is highly reactive and combines with malodor molecules to chemically alter their structure and rid property of odor. Ozone also kills bacteria and fungi and works as a sanitizing agent.

Ozone may be formed from O2 by electrical discharges and by action of high energy electromagnetic radiation. Certain electrical equipment generates significant levels of ozone. This is especially true of devices using high voltages. Electric motors using brushes can generate ozone from repeated sparking inside the unit. Ozone can also be prepared by passing 10,000-20,000 volts DC through dry O2.

The best way to utilize ozone for killing microbes is to dissolve ozone in water, producing ozone water, which possess effect of sterilization and antiseptic. Ozone water is the best washing and drinking water for its characteristic of sterilizing and leaving no remnant. Ozone water also kills bacteria and yeast in drainpipes. Further, ozone is used commercially as a powerful oxidizer, disinfectant and decontaminant. The active ozone easily reduces to oxygen. The allowed concentration of ozone in water is 0.1 PPM in sanitation application.

Thus, the invention provides a water reservoir that comprises a water storage unit having an external water pipe connected to an external water source and one or a number of internal water pipes suspending therein, airstones wrapped about each internal water pipe corresponding to jet holes of each internal water pipe, and an ozone generator installed in between the external water pipe and the internal water pipes for generating ozone into water passing through the external water pipe and the internal water pipes into the inside of the water storage unit.

Further, a water level sensor installed in the water storage unit and electrically connected to the ozone generator and adapted for sensing the level of water in the water storage unit and controlling the operation of the ozone generator subject to its sensing operation.

### BRIEF DESCRIPTION OF THE DRAWINGS

FIG. 1 is schematic sectional view of a water reservoir in accordance with a first embodiment of the present invention.

FIG. 2 is schematic sectional view of a water reservoir in accordance with a second embodiment of the present invention.

FIG. 3 is an enlarged view of a part of the water reservoir in accordance with the second embodiment of the present invention, showing the arrangement of the internal water pipes.

### DETAILED DESCRIPTION OF THE PREFERRED EMBODIMENT

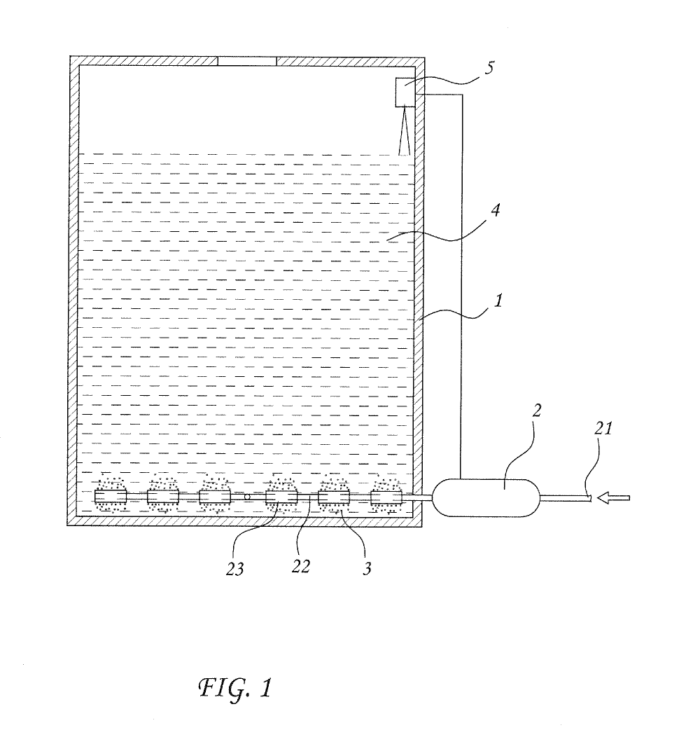

Referring to FIG. 1, a water reservoir in accordance with one embodiment of the present invention is shown comprising a water storage unit 1, an ozone generator 2.

The water storage unit 1 can be made in the form of a water tower and installed in a building at a high place. Alternatively, the water storage unit 1 can be made in the form of a water tank and installed in the basement of a building. The ozone generator 2 is installed in between an external water pipe 21 that connects to an external water source, and an internal water pipe 22 that suspends inside of the water storage unit 1. The internal water pipe 22 has multiple jet holes (not shown) spaced along the length. Further, airstones 23 are wrapped about the periphery of the internal water pipe 22 around the jet holes. The airstones are pieces of porous stones adapted for producing larger bubbles and letting in more oxygen, enhancing distribution of ozone generated by the ozone generator 2 in the water stored in the water storage unit 1 to achieve an effective sterilization effect and to prohibit formation of green moss or scale.

In an alternate form of the present invention, multiple internal water pipes 22 are connected to one another in different directions inside the water storage unit 1, and airstones 23 are wrapped about the periphery of each internal water pipe 22 around the respective jet holes.

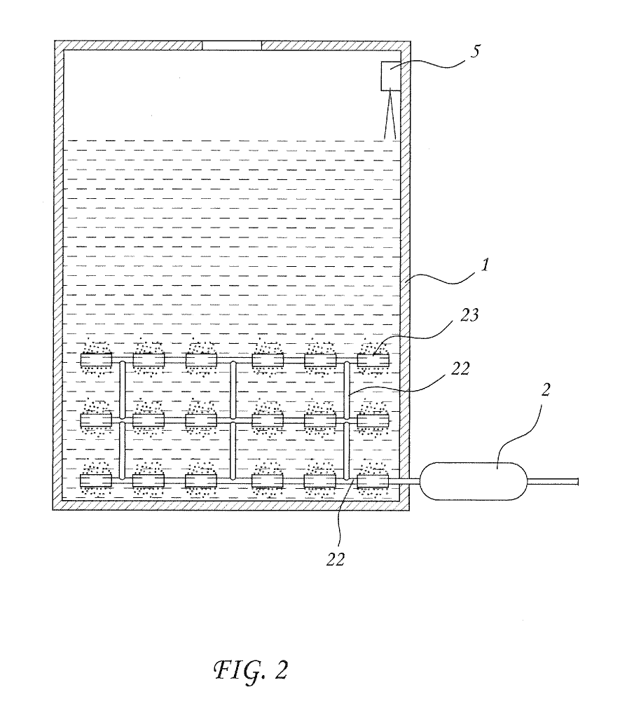

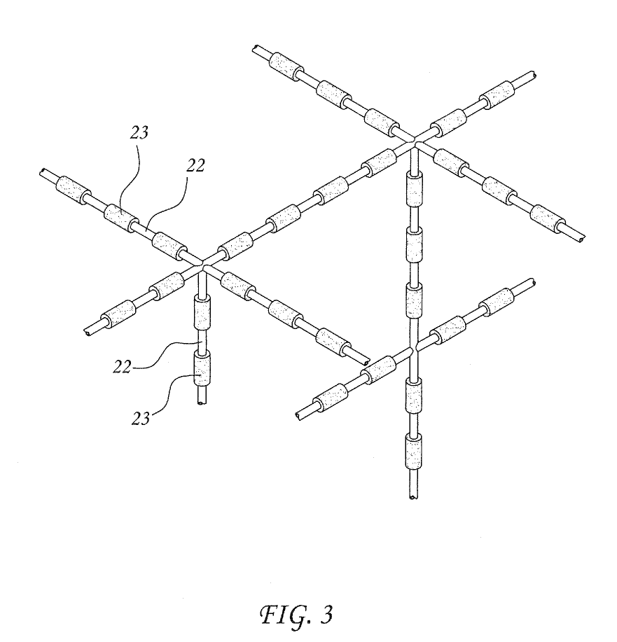

Referring to FIGS. 1-3 again, a water level sensor 5 is installed in the water storage unit 1 and electrically connected to the ozone generator 2. When the water level in the water storage unit 1 reaches a predetermined elevation, the water level sensor 5 is induced to provide a signal to the ozone generator 2, driving the ozone generator 2 to generate ozone.

Although particular embodiments of the invention have been described in detail for purposes of illustration, various modifications and enhancements may be made without departing from the spirit and scope of the invention. Accordingly, the invention is not to be limited except as by the appended claims.

I claim:

1. A water reservoir, comprising:
a water storage unit for storing water;
an external water pipe connected to said water storage unit and adapted for guiding water from an external water source into said water storage unit;
at least one internal water pipe suspending in said water storage unit and connected to said external water pipe for guiding in water, each said internal water pipe having a plurality of jet holes;
a plurality of airstones wrapped about said at least one internal water pipe corresponding to the jet holes of said at least one internal water pipe; and
an ozone generator installed in between said external water pipe and said at least one internal water pipe and adapted for generating ozone into water passing through said external water pipe and said at least one internal water pipe into the inside of said water storage unit.

2. The water reservoir as claimed in claim 1, wherein at least one internal water pipe is arranged at different elevations in said water storage unit.

3. The water reservoir as claimed in claim 1, further comprising a water level sensor installed in said water storage unit and electrically connected to said ozone generator and adapted for sensing the level of water in said water storage unit and controlling the operation of said ozone generator subject to sensing operation thereof.
